(19) United States
(12) Patent Application Publication
(10) Pub. No.: US 2014/0153533 A1
(43) Pub. Date: Jun. 5, 2014

(54) Method and Base Station for Informing Power Message

(71) Applicants: Yijian Chen, Shenzhen (CN); Yu Ngok Li, Shenzhen (CN); Bo Dai, Shenzhen (CN); Zhisong Zuo, Shenzhen (CN); Yong Li, Shenzhen (CN)

(72) Inventors: Yijian Chen, Shenzhen (CN); Yu Ngok Li, Shenzhen (CN); Bo Dai, Shenzhen (CN); Zhisong Zuo, Shenzhen (CN); Yong Li, Shenzhen (CN)

(73) Assignee: ZTE CORPORATION, Shenzhen City, Guangdong Province (CN)

(21) Appl. No.: 14/233,942

(22) PCT Filed: Dec. 14, 2011
(86) PCT No.: PCT/CN2011/083921

§ 371 Date: Jan. 21, 2014

(30) Foreign Application Priority Data
Aug. 9, 2011 (CN) 201110226899.5

(51) Int. Cl. H04W 72/04; H04W 52/04

(52) U.S. Cl. CPC H04W 72/0406; H04W 52/04
USPC 370/329

(57) ABSTRACT

A method for informing about power information and a base station are disclosed in the present document. The method includes: a base station informing a user equipment of at least one of the following types of power ratio information through signalings: ratio information of transmission power for transmitting a second category of control signaling information to transmission power for transmitting dedicated demodulation pilots; and ratio information of transmission power for transmitting data information to transmission power for transmitting dedicated demodulation pilots in a subframe where data transmission occupies only one slot. In the example of the present document, when the second category of control signalings and the data are sent, different transmission layers and transmission powers can be selected, which solves the problem resulted from an inconsistency of Demodulation Reference Signal (DMRS) powers and avoids a demodulation error.

### TECHNICAL FIELD

The present document relates to the field of communication, and particularly, to a method for informing about power information in a communication system and a base station.

### BACKGROUND OF THE RELATED ART

In the Release (R) 8/9 of a Long Term Evolution (LTE) system and the R10 of an LTE-Advanced system, a downlink control signaling is generally configured to be sent on the first N Orthogonal Frequency Division Multiplexing (OFDM) symbols of one Subframe (with reference to a definition with regard to the Subframe in the 3rd Generation Partnership Project (3GPP) TS 36.211) , and those N symbols are generally called as a control signaling transmission area of a subframe. Here, in order to distinguish from a control signaling transmission area newly added in the new release, the control signaling transmission area of the R8/9/10 is called as a first control signaling transmission area in the present document.

The available transmission resources of the first control signaling transmission area are divided into multiple Control Channel Element (CCE) resource units, the resources occupied by the control information are allocated with CCE being a unit, a resource unit CCE here also can be further subdivided into multiple Resource Element Groups (REGs), a CCE consists of multiple discontinuous REGs, and normally 9 REGs constitute a CCE, and each REG is further composed of multiple basic resource units.

It can be seen that the control signaling transmission resources allocated by users are discontinuous, this brings a lot of difficulties in implementing the closed-loop precoding technology in a multi-antenna system, which causes that only the diversity technology can be used and the closed-loop precoding technology is difficult to be used in the control signaling area. The main reason is that, when the closed-loop precoding technology is used in the first control signaling transmission area, there exists a great design difficulty in the aspect of demodulation pilots and channel state information feedback, thus all control signalings in the existing releases only support the discontinuous resource transmission and the diversity technology.

In the releases after the R10, in order to enhance the transmission capacity of control channels and support the control signalings of more users, it is to consider to open up new control channel areas, and control signaling transmission resources of the same User Equipment (UE) can be continuous time-frequency resources so as to support the closed-loop precoding technology, thereby enhancing the transmission performance of control information.

Control signaling areas of the new releases (i.e., the releases after the Release 10 (called as the R10 for short)) and the old releases (i.e., the Release 8/9/10) is as shown in FIG. 1.

In this method, in a Physical Downlink Shared Channel (PDSCH) transmission area of the original R8/9/10, part of transmission resources are set apart to serve as a second control signaling transmission area, such that the closed-loop precoding technology can be supported when the control signallings are transmitted, thereby enhancing the control signalling capacity and supporting transmission of the control signallings of more users.

Here, in the second control signaling transmission area, a dedicated Demodulation Reference Signal (DMRS) in the R10 can be reused to demodulate the control signalings, which supports the precoding technology well. Due to the appearance of the second control signaling transmission area, the DMRS not only needs to support data demodulation, but also needs to support demodulation of the second category of control signalings transmitted within the first control signaling transmission area, and a new research subject is how to achieve the optimal downlink transmission under this condition.

FIG. 2 is a schematic diagram of distribution of the second category of control signalings and data information transmitted within a transmission resource block. The distributed situation of the second category of control signalings and data information shown in FIG. 2 can be further represented as shown in FIG. 3.

In order to waste no resources and avoid scheduling restrictions, situations where the data information and the second category of downlink control signalings are transmitted in an identical Resource Block (RB) shown in FIG. 2 and FIG. 3 will appear frequently. Only one situation is listed in this example, and of course, other situations are also included in practice.

Scheme 1: the second category of control signalings is demodulated by using DMRSs on the 6th OFDM symbol and the 7th OFDM symbol in FIG. 3, and the data information is demodulated by using DMRSs on the 13th OFDM symbol and the 14th OFDM symbol in FIG. 3.

The scheme 1 is actually equivalent to that the second category of control signalings and the data information are demodulated by using half of the DMRSs respectively, the demodulation performance will be reduced, and the channel estimation has no time-domain interpolation. Secondly, due to the truncation of DMRS, the transmission of data information of the second Slot (referring to a definition for the Slot in the 3GPP TS36.211) cannot support the transmission of layer 5, layer 6, layer 7 and layer 8 anymore, which loses the transmission ability of supporting 8 layers at most of the Multiple Input and Multiple Output (MIMO) when there are 8 antennas, but can only support 4 layers.

Scheme 2: the second category of control signalings is demodulated by using DMRSs on the 6th OFDM symbol, the 7th OFDM symbol, the 13th OFDM symbol and the 14th OFDM symbol in FIG. 3, the data information is also modulated by using the DMRSs on the 6th OFDM symbol, the 7th OFDM symbol, the 13th OFDM symbol and the 14th OFDM symbol in FIG. 3, but it is limited to using the identical DMRS port. Therefore, normal demodulation can be performed without truncating when using the existing DMRSs. However, since the identical DMRS port is used, the method brings certain limitations. For example,

the data and the control signalings are required to use the same transmission layer number and transmission power; or

the data information and the second category of control signalings are required to belong to an identical user.

The defects of the scheme 2 are that, the control signalings are appropriate for being transmitted in less layers, the data may be appropriate for being transmitted in more layers, the same number of layers brings the limitations. The robustness of control signalings is different from the transmission robustness requirements of data information, thus transmission powers may also be different, and the limitation of same power may also bring other problems. In addition, both the data information and the second category of control signaling information are required to belong to an identical user, which will have limitations on the scheduling in practice, go against the flexibility of scheduling, and have a certain extent of loss of scheduling gain.

### SUMMARY OF THE INVENTION

The technical problem required to be solved by the present document is to overcome the defect of more limitations when the second category of control signalings and data are sent in one subframe in the related art.

In order to solve the above technical problem, the present document firstly provides a method for informing about power information, which comprises:

a base station informing a user equipment of at least one of the following types of power ratio information through signalings:

ratio information of transmission power for transmitting a second category of control signaling information to transmission power for transmitting dedicated demodulation pilots; and

ratio information of transmission power for transmitting data information to transmission power for transmitting dedicated demodulation pilots in subframes where data transmission occupies only one slot.

Preferably, the ratio information of the transmission power for transmitting the second category of control signaling information to the transmission power for transmitting the dedicated demodulation pilots includes: a ratio of the transmission power for the base station transmitting the second category of control signaling information to the transmission power for the base station transmitting the dedicated demodulation pilot, or a ratio of the transmission power for the base station transmitting the dedicated demodulation pilots to the transmission power for the base station transmitting the second category of control signaling information; and

the ratio information of the transmission power for transmitting the data information to the transmission power for transmitting the dedicated demodulation pilots includes: a ratio of the transmission power for the base station transmitting the data information to the transmission power for the base station transmitting the dedicated demodulation pilots, or a ratio of the transmission power for the base station transmitting the dedicated demodulation pilots to the transmission power for the base station transmitting the data information.

Preferably, the signalings include high layer signalings or physical layer signalings.

Preferably, the base station transmits the physical layer signalings in a first control signaling area.

Preferably, the base station semi-statically sends and/or updates the power ratio information through the high layer signalings.

Preferably, the power ratio information is a set of numerical values with decibel as a unit.

Preferably, the set of numerical values includes {−6,−3,−1,0,1,3,6,9}.

Preferably, the signalings are of 3 bits.

The present document further provides a base station, the base station is configured to: inform a user equipment of at least one of the following types of power ratio information through signalings:

ratio information of transmission power for transmitting a second category of control signaling information to transmission power for transmitting dedicated demodulation pilots; and

ratio information of transmission power for transmitting data information to transmission power for transmitting dedicated demodulation pilots in subframes where data transmission occupies only one slot.

Preferably, the base station is configured as that, the informed ratio information of the transmission power for transmitting the second category of control signaling information to the transmission power for transmitting the dedicated demodulation pilots includes: a ratio of the transmission power for the base station transmitting the second category of control signaling information to the transmission power for the base station transmitting the dedicated demodulation pilots, or a ratio of the transmission power for the base station transmitting the dedicated demodulation pilots to the transmission power for the base station transmitting the second category of control signaling information; and

the base station is configured as that, the informed ratio information of the transmission power for transmitting the data information to the transmission power for transmitting the dedicated demodulation pilots includes: a ratio of the transmission power for the base station transmitting the data information to the transmission power for the base station transmitting the dedicated demodulation pilots, or a ratio of the transmission power for the base station transmitting the dedicated demodulation pilots to the transmission power for the base station transmitting the data information.

Preferably, the base station is configured to: inform the user equipment through high layer signalings or physical layer signalings.

Preferably, the base station is further configured to: transmit the physical layer signalings in a first control signaling area.

Preferably, the base station is further configured to: semi-statically send and/or update the power ratio information through the high layer signalings.

Preferably, the power ratio information informed by the base station is a set of numerical values with decibel as a unit.

Preferably, the set of numerical values includes {−6, −3, −1, 0,1,3, 6,9}.

Preferably, the signalings for the base station performing informing are of 3 bits.

Compared with the related art, in the example of the present document, when the second category of control signalings and the data are sent, different transmission layers and transmission powers can be selected. The data information and the second category of control signalings can belong to different users in the example of the present document. The problem resulted from the inconsistency of DMRS powers is solved in the example of the present document, which avoids a demodulation error. The problem of limitation of the same power in the scheme 2 is also solved in the example of the present document.

Other characteristics and advantages of the present document will be elaborated in the following descriptions, and will become partially apparent through the descriptions, or will be understood by implementing the present document. The object and other advantages of the present document can be implemented and obtained through the structures particularly pointed in the descriptions, claims and accompanying drawings.

### BRIEF DESCRIPTION OF DRAWINGS

The accompanying drawings are used to provide a further understanding of the technical scheme of the present document and constitute a part of the descriptions, and are used to explain the technical scheme of the present document together with the examples of the present document, but do not constitute a limitation on the technical scheme of the present document. In the drawings:

FIG. 1 is a schematic diagram of control signaling areas of a new release and an old release in the current LTE system.

FIG. 2 is a schematic diagram of distribution of the second category of control signalings and data information transmitted within one transmission resource block.

FIG. 3 is another schematic diagram of distribution of the second category of control signalings and data information transmitted within one transmission resource block.

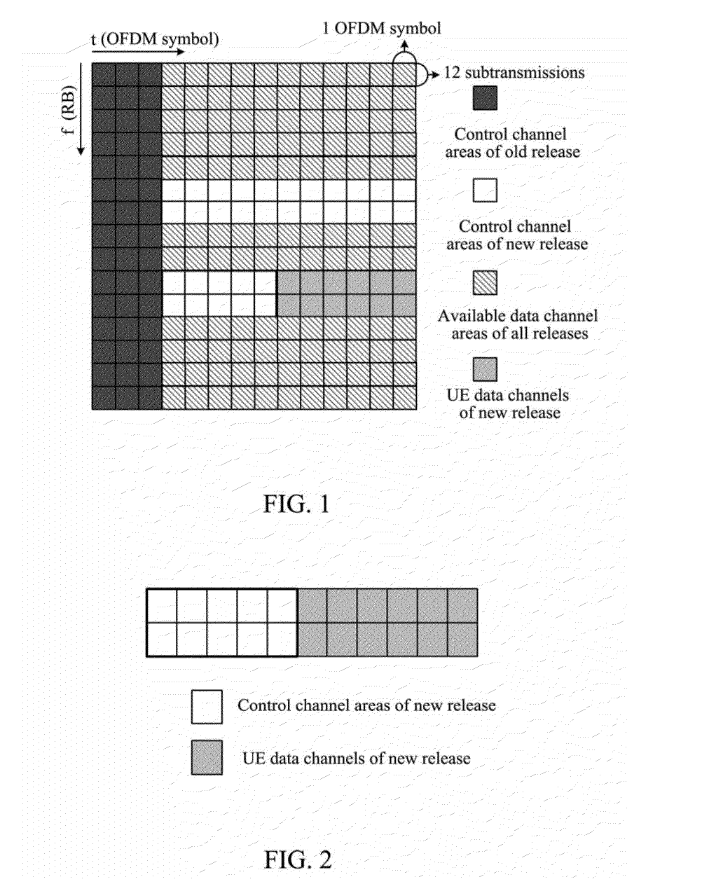

### PREFERRED EMBODIMENTS OF THE INVENTION

The embodiments of the present document will be described in detail in combination with the accompanying drawings and examples, whereby an implementation process of how to apply the technical means to solve the technical problems in the present document and achieve the technical effects can be fully understood and accordingly executed.

As known from an analysis of the related art, the scheme 1 is a method with bad performance, and the problem of the scheme 2 lies in that there exists many limitations. In the example of the present document, it has no limit on that the data information and the second category of control signalings are required to use the same layer number, and it also has no limit on that the data information and the second category of control signalings are required to come from the same user.

Since demodulation pilots are shared, power of the demodulation pilots can only be equal to one of the power of the control signalings and the power of the data information, therefore, when the power of the control signalings and the power of the data information are different, the demodulation of one kind of the above will have a problem.

In the method for informing about power information of the example of the present document, a base station informs a user equipment of at least one of the following types of power ratio information through signalings:

ratio information of transmission power for transmitting the second category of control signaling information to transmission power for transmitting dedicated demodulation pilots; and

ratio information of transmission power for transmitting data information to transmission power for transmitting dedicated demodulation pilots in a subframe where data transmission occupies only one slot.

In the example of the present document, the signalings can be high layer signalings or physical layer signalings. Wherein, the physical layer signalings are transmitted in the first control signaling area.

In the example of the present document, the base station semi-statically sends and/or updates the power ratio information through the high layer signalings.

In the example of the present document, the power ratio information informed by the base station is a set of numerical values with decibel as a unit, and the signalings can be of 3 bits.

The base station of the example of the present document informs the user equipment of at least one of the following types of power ratio information through signalings:

ratio information of transmission power for transmitting the second category of control signaling information to transmission power for transmitting dedicated demodulation pilots; and

ratio information of transmission power for transmitting data information to transmission power for transmitting dedicated demodulation pilots in a subframe where data transmission occupies only one slot.

In the example of the present document, the base station informs the user equipment through the high layer signalings or the physical layer signalings.

In the example of the present document, the base station semi-statically sends and/or updates the power ratio information through the high layer signalings.

In the example of the present document, the base station transmits the physical layer signalings in the first control signaling area.

In the example of the present document, the power ratio information informed by the base station is a set of numerical values with decibel as a unit, and the signalings can be of 3 bits.

In the foregoing examples of the present document, the ratio information can be a ratio of the former to the latter, and also can be a ratio of the latter to the former. For example, the ratio information of the transmission power for transmitting the second category of control signaling information to the transmission power for transmitting the dedicated demodulation pilots includes: a ratio of the transmission power for transmitting the second category of control signaling information to the transmission power for transmitting the dedicated demodulation pilots, or a ratio of the transmission power for transmitting the dedicated demodulation pilots to the transmission power for transmitting the second category of control signaling information. For another example, the ratio information of the transmission power for transmitting the data information to the transmission power for transmitting the dedicated demodulation pilots includes: a ratio of the transmission power for transmitting the data information to the transmission power for transmitting the dedicated demodulation pilots, or a ratio of the transmission power for transmitting the dedicated demodulation pilots to the transmission power for transmitting the data information.

In the example of the present document, the problem resulted from the inconsistency between the transmission powers for transmitting the control signalings and the transmission power for transmitting the data information is solved, which avoids a demodulation error. In another example of the present document, the problem of limitation of the same transmission power in the existing scheme 2 is solved.

In the first practical application of the present document, the base station demodulates the second category of control information and the data information by using the same DMRS port for the same user, and informs about the transmission power ratio information through the signalings.

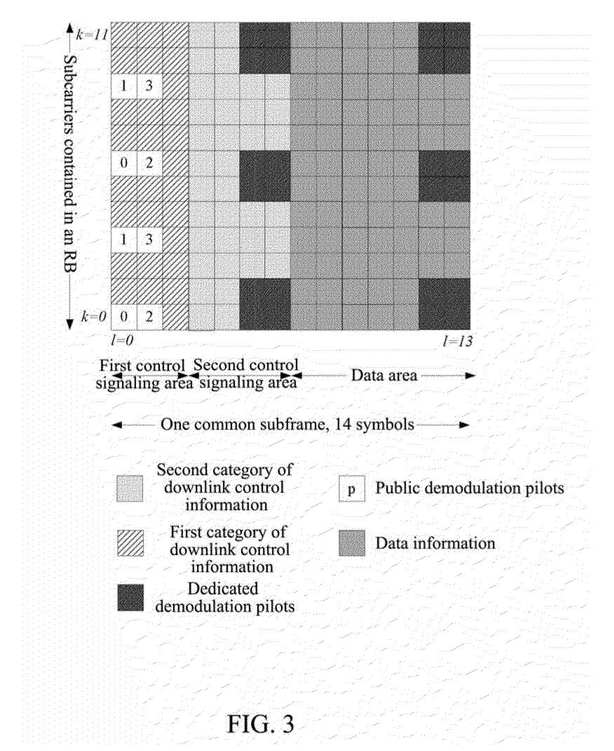

Specifically, the base station transmits the second category of control information of a user 1 at the locations of available transmission resources of the first Slot as shown in FIG. 3, and transmits the data information of the user 1 at the locations of available transmission resources of the second Slot as shown in FIG. 3.

The transmission power used when the base station transmits the second category of control information of the user 1 is Pa, and the transmission power used when the base station transmits the data information of the user 1 is Pb.

A demodulation pilot port used when the base station transmits the second category of control information of the user 1 is a DMRS Port7, and a demodulation pilot port used when the base station transmits the data information of the user 1 is also the DMRS Port7.

The transmission power of the DMRS Port7 is Pa′, Pb′ or Pa′+Pb′. Generally, there exist a linear relationship between Pa and Pa′ and a linear relationship between Pb and Pb′.

It is assumed that, the DMRS power is Pa′+Pb′, the base station informs the user 1 of the ratio information of the transmission power Pa used when transmitting the second category of control information to the transmission power Pa′+Pb′ used when transmitting the DMRS information through the signalings; and the base station informs the user 1 of the ratio information of the transmission power Pb used when transmitting the data information to the transmission power Pa′+Pb′ used when transmitting the DMRS information through the signalings.

It also can be regulated that, the transmission power of the DMRS Port 7 is Pa′=Pa, and meanwhile, the base station only informs the user 1 of the ratio information of the transmission power Pb used when transmitting the data information to the transmission power Pa′ used when transmitting the DMRS information through the signalings.

It also can be regulated that, the transmission power of the DMRS Port 7 is Pb′=Pb, and meanwhile, the base station only informs about the ratio information of the transmission power Pa used when transmitting the second category of control information to the transmission power Pb′ used when transmitting the DMRS information through the signalings.

The second practical application of the present document is similar to the first practical application, the difference is that the transmission powers of the DMRS are the same on different Slots in the first practical application, but the transmission powers of the DMRS may be different on different Slots in the current practical application.

Specifically, the base station transmits the second category of control information of the user 1 at the locations of available transmission resources of the first Slot as shown in FIG. 3, and transmits the data information of the user 1 at the locations of available transmission resources of the second Slot as shown in FIG. 3.

The transmission power used when the base station transmits the second category of control information of the user 1 is Pa, and the transmission power used when the base station transmits the data information of the user 1 is Pb.

A demodulation pilot port used when the base station transmits the second category of control information of the user 1 is a DMRS Port7, and a demodulation pilot port used when the base station transmits the data information of the user 1 is also the DMRS Port7.

The transmission power of the DMRS Port7 on the first Slot is Pa′, and the transmission power of the DMRS Port7 on the second Slot is Pb′.

Through the signalings, the base station informs the user 1 of the ratio of the transmission power Pa for transmitting the second category of control information to the transmission power Pa′ for transmitting the DMRS on the first Slot, and informs the user 1 of the ratio information of the transmission power Pb for transmitting the data information to the transmission power Pb′ for transmitting the DMRS on the second Slot.

In the third practical application of the present document, the base station transmits the second category of control information of the user 1 at the locations of available transmission resources of the first Slot as shown in FIG. 3, and transmits the data information of the user 1 at the locations of available transmission resources of the second Slot as shown in FIG. 3.

The transmission power used when the base station transmits the second category of control information of the user 1 is Pa, and the transmission power used when the base station transmits the data information of the user 1 is Pb.

A demodulation pilot port used when the base station transmits the second category of control information of the user 1 is a DMRS Port7, and demodulation pilot ports used when the base station transmits the data information of the user 1 are DMRS Port7, DMRS Port8, DMRS Port9 and DMRS Port10.

Wherein, the transmission power of the DMRS Port7 is Pa′, and the transmission powers of the DMRS Port7, DMRS Port8, DMRS Port9 and DMRS Port10 are Pb's, and the Pb is generally equal to 4Pa′.

The base station informs the user 1 of the ratio information of the transmission power Pa for transmitting the second category of control information to the transmission power Pa′ of the transmission power for the DMRS Port7 through the signalings.

In the forgoing practical applications of the present document, the base station informs about the transmission power ratio information through the signalings, the power ratio information can be semi-statically sent and/or updated through the high layer signalings. Wherein, the power ratio information can be a set of numerical values, such as {−6, −3, −1, 0,1,3, 6, 9}, its unit is decibel (dB), and notification is performed through a 3-bit signaling.

In the practical applications of the present document, the base station indicates power ratio information of the current subframe through the physical layer signaling in the first control signaling area. Wherein, the power ratio information can be a set of numerical values, such as {−6, −3, −1, 0,1,3, 6, 9}, its unit is decibel (dB), and notification is performed through a 3-bit signaling.

Though the embodiment disclosed by the present document is described as above, the contents mentioned are just the embodiment adopted for an easy understanding of the present document, which is not used to limit the present document. Any skilled in the art to which the present document belongs can make any modifications and changes of forms and details of the implementation in the premise of not departing from the spirit and scope disclosed by the present document, but the patent protection scope of the present document should still be subject to the scope defined by the appended claims.

### INDUSTRIAL APPLICABILITY

In the example of the present document, when the second category of control signalings and the data are sent, different transmission layers and transmission powers can be selected. The data information and the second category of control signalings can belong to different users in the example of the present document. The problem resulted from the inconsistency of DMRS powers is solved in the example of the present document, which avoids a demodulation error. The problem of limitation of the same power is also solved in the example of the present document.

What is claimed is:

1. A method for informing about power information, comprising:
a base station informing a user equipment of at least one of the following types of power ratio information through signalings:
ratio information of transmission power for transmitting a second category of control signaling information to transmission power for transmitting dedicated demodulation pilots; and
ratio information of transmission power for transmitting data information to transmission power for transmitting dedicated demodulation pilots in subframes where data transmission occupies only one slot.

2. The method according to claim 1, wherein:
the ratio information of the transmission power for transmitting the second category of control signaling information to the transmission power for transmitting the dedicated demodulation pilots comprises: a ratio of the transmission power for the base station transmitting the second category of control signaling information to the transmission power for the base station transmitting the dedicated demodulation pilot, or a ratio of the transmission power for the base station transmitting the dedicated demodulation pilots to the transmission power for the base station transmitting the second category of control signaling information; and
the ratio information of the transmission power for transmitting the data information to the transmission power for transmitting the dedicated demodulation pilots comprises: a ratio of the transmission power for the base station transmitting the data information to the transmission power for the base station transmitting the dedicated demodulation pilots, or a ratio of the transmission power for the base station transmitting the dedicated demodulation pilots to the transmission power for the base station transmitting the data information.

3. The method according to claim 1, wherein:
the signalings comprise high layer signalings or physical layer signalings.

4. The method according to claim 3, wherein:
the base station transmits the physical layer signalings in a first control signaling area.

5. The method according to claim 3, wherein:
the base station semi-statically sends and/or updates the power ratio information through the high layer signalings.

6. The method according to claim 1, wherein:
the power ratio information is a set of numerical values with decibel as a unit.

7. The method according to claim 6, wherein:
the set of numerical values comprises {−6, −3, −1, 0,1, 3, 6, 9}.

8. The method according to claim 1, wherein:
the signalings are of 3 bits.

9. A base station, wherein: the base station is configured to: inform a user equipment of at least one of the following types of power ratio information through signalings:
ratio information of transmission power for transmitting a second category of control signaling information to transmission power for transmitting dedicated demodulation pilots; and
ratio information of transmission power for transmitting data information to transmission power for transmitting dedicated demodulation pilots in a subframe where data transmission occupies only one slot.

10. The base station according to claim 9, wherein:
the base station is configured as that, the informed ratio information of the transmission power for transmitting the second category of control signaling information to the transmission power for transmitting the dedicated demodulation pilots comprises: a ratio of the transmission power for the base station transmitting the second category of control signaling information to the transmission power for the base station transmitting the dedicated demodulation pilots, or a ratio of the transmission power for the base station transmitting the dedicated demodulation pilots to the transmission power for the base station transmitting the second category of control signaling information; and
the base station is configured as that, the informed ratio information of the transmission power for transmitting the data information to the transmission power for transmitting the dedicated demodulation pilots comprises: a ratio of the transmission power for the base station transmitting the data information to the transmission power for the base station transmitting the dedicated demodulation pilots, or a ratio of the transmission power for the base station transmitting the dedicated demodulation pilots to the transmission power for the base station transmitting the data information.

11. The base station according to claim 9, wherein:
the base station is configured to: inform the user equipment through high layer signalings or physical layer signalings.

12. The base station according to claim 11, wherein:
the base station is further configured to: transmit the physical layer signalings in a first control signaling area.

13. The base station according to claim 11, wherein:
the base station is further configured to: semi-statically send and/or update the power ratio information through the high layer signalings.

14. The base station according to claim 9, wherein:
the power ratio information informed by the base station is a set of numerical values with decibel as a unit.

15. The base station according to claim 14, wherein:
the set of numerical values comprises {−6,−3,−1,0,1,3,6,9}.

16. The base station according to claim 9, wherein:
the signalings for the base station performing informing are of 3 bits.
